(19) United States
(12) Patent Application Publication
(10) Pub. No.: US 2008/0028464 A1
(43) Pub. Date: Jan. 31, 2008

(54) Systems and Methods for Data Processing Anomaly Prevention and Detection

(76) Inventors: Michael Paul Bringle, Irvine, CA (US); Jason Scott Coombs, Kohala, HI (US)

Correspondence Address: MCANDREWS HELD & MALLOY, LTD, 500 WEST MADISON STREET, SUITE 3400, CHICAGO, IL, 60661, US

(21) Appl. No.: 11/828,200

(22) Filed: Jul. 25, 2007

Related U.S. Application Data
(60) Provisional application No. 60/833,237, filed on Jul. 25, 2006.

(51) Int. Cl. G06F 21/00

(52) U.S. Cl. 726/22; 713/189

(57) ABSTRACT

Certain embodiments of the present invention provide a system for data processing anomaly detection including a database including anomaly data and an anomaly processing component adapted to detect a structure anomaly in data based at least in part on the database including anomaly data. The data is meant to be processed by an application including at least one of data structure decoding logic and circuitry after the anomaly processing component has processed the data. The anomaly processing component is adapted to prevent the application from processing the data when a structure anomaly is detected.

### RELATED APPLICATIONS

This application is related to, and claims the benefit of, Provisional Application No. 60/833,237, filed on Jul. 25, 2006, and entitled “A System or Method of Creating Cryptographic Command or Control Channels with Layers of Digital Signature Authentication or Verification of Digital Communications Enabling Remote Control Over, or Distribution of Arbitrary Reprogramming or Reconfiguration Instructions to, One or More General Purpose Programmable Electronic Devices.” The foregoing application is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to data processing. More particularly, the present invention relates to data processing anomaly prevention and detection.

Current computing systems are vulnerable to data processing anomalies. Such anomalies may come about through malicious and/or malformed data provided to an application. Such anomalies are particularly problematic for desktop computers.

The rising tide of port 80 (that is, the port that is utilized by the hypertext transfer protocol (the Web)) vulnerabilities are becoming a critical problem in desktop security. Browser exploits lead to spyware, Trojans, and backdoors. In addition, the risk of another major worm event remains serious. The growth of the mobile workforce is creating an environment where perimeter security is ineffective. Threats are frequently introduced behind perimeter defenses.

Many of these exploits are achieved by malicious data that is malformed to take advantage of the way applications process the data. By knowing how an application processes data, unaccounted for conditions or bugs may be exploited to trick the application into executing arbitrary instructions contained within the malicious and/or malformed data. As a result, an outsider may be able to “take control” of the system. In addition to port 80 vulnerabilities, other forms of ubiquitous communication methods, such as email, instant messaging, and even digital voice or video chat, also share similar risks. But in these cases instead of a user navigating to compromised pages with a Web browser, the malicious payloads, such as an email with a malformed image that contains a buffer overflow exploit, can be sent unsolicited to the user's computer, taking control of it due to automated structured data handling routines that process the incoming data. Numerous vulnerabilities exist in Microsoft Outlook so that a user's computer security is compromised even if a user never reads the malicious email messages that Outlook receives, yet because the Outlook application automatically processes structured data that might be maliciously-malformed by an attacker there is no way for Outlook users to defend themselves.

Anomalous data can also be transmitted through other vectors such as disk, CD, floppy drive, flash memory cards, USB flash memory storage devices, and even information sharing between personal computers and digital cameras or smart phones that include data storage capability. Given that windows scans files for devices inserted in the system, or viewed by the Windows Explorer, vulnerabilities can be exploited without the user even executing or intentionally viewing a maliciously-malformed data file. The Metafile vulnerability can be exploited in this way, for example. The Windows operating system will attempt to process Metafile files in order to automatically collect data about the images or generate thumbnails, thus launching the exploit.

### BRIEF SUMMARY OF THE INVENTION

Certain embodiments of the present invention provide a system for data processing anomaly detection including a database including anomaly data and an anomaly processing component adapted to detect a structure anomaly in data based at least in part on the database including anomaly data. The data is meant to be processed by an application including at least one of data structure decoding logic and circuitry after the anomaly processing component has processed the data. The anomaly processing component is adapted to prevent the application from processing the data when a structure anomaly is detected.

Certain embodiments of the present invention provide a system for data processing anomaly detection including an anomaly processing component adapted to enable a user to decide whether programming instructions for an application are updated with new programming instructions when at least one of the application is not otherwise designed to give the user this ability to decide and the application includes a module that must be updated whenever programming instructions are updated.

Certain embodiments of the present invention provide a system for data processing anomaly detection including a database including a data structure specification and an anomaly processing component adapted to detect an attempt to decode data of at least one of a Windows Metafile and an Enhanced Metafile data structure. The data structure specification includes information about the structure of at least one of a Windows Metafile and an Enhanced Metafile data structure. The anomaly processing component is further adapted verify that the data complies with rules derived from the data structure specification.

Certain embodiments of the present invention provide a system for data processing anomaly detection including a database including anomaly data and an anomaly processing component adapted to detect prior to the execution of new programming instructions that the new programming instructions were created prior in time to existing programming instructions based at least in part on the anomaly data, wherein the existing programming instructions are to be updated with the new programming instructions.

Certain embodiments of the present invention provide a system for data processing anomaly detection including an anomaly processing component adapted to receive data using an address. The anomaly processing component is further adapted to require the use of an address that requires decryption of the received data when an address that does not require decryption of the received data is otherwise available.

Certain embodiments of the present invention provide a method for data processing anomaly detection including verifying new programming instructions by forensically examining the new programming instructions and communicating the verified new programming instructions to a host adapted to install the verified new programming instructions. The new programming instructions are not examined solely by an automated system and wherein the new programming instructions are visually inspected by a human being.

### BRIEF DESCRIPTION OF SEVERAL VIEWS OF THE DRAWINGS

FIG. 1 illustrates a system for data processing anomaly prevention and detection according to embodiments of the present invention.

FIG. 2 illustrates a system for delivery of data processing anomaly prevention and detection updates according to an embodiment of the present invention.

FIG. 3 illustrates a system for data processing anomaly prevention and detection in accordance with an embodiment of the present invention.

FIG. 4 illustrates a system for data processing anomaly prevention and detection in accordance with an embodiment of the present invention.

FIG. 5 illustrates a system for data processing anomaly prevention and detection in accordance with an embodiment of the present invention.

FIG. 6 illustrates a system for data processing anomaly prevention and detection according to an embodiment of the present invention.

FIG. 7 illustrates a system for data processing anomaly prevention and detection according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

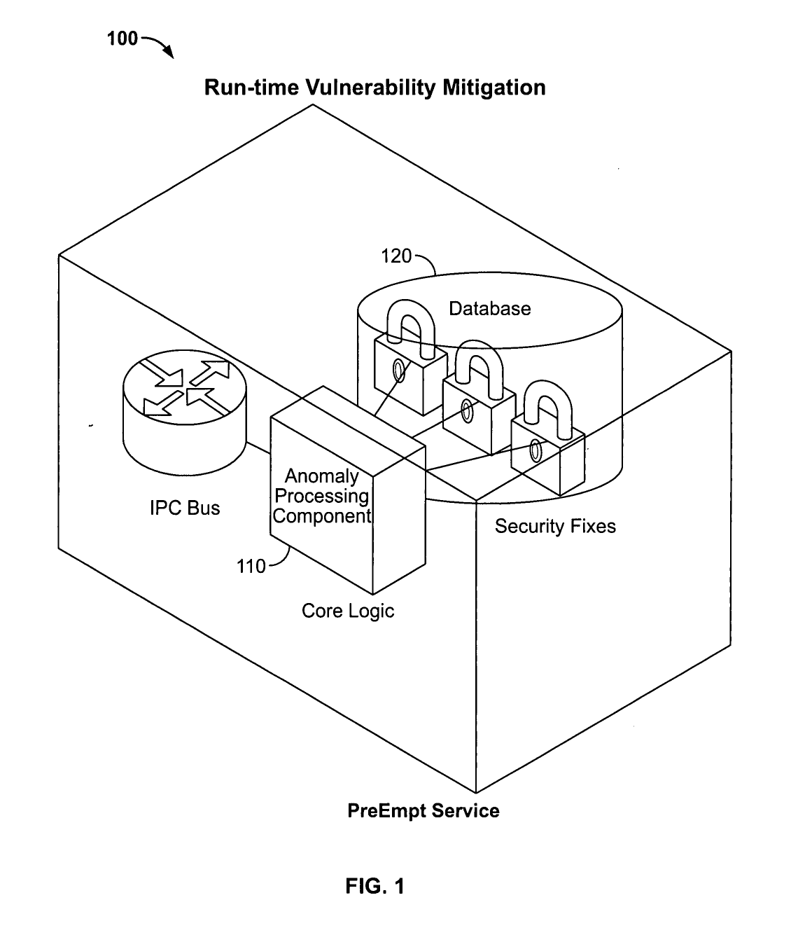

FIG. 1 illustrates a system 100 for data processing anomaly prevention and detection according to an embodiment of the present invention. The system 100 includes an anomaly processing component 110 and a database 120.

The anomaly processing component 110 is in communication with the database 120.

In operation, the anomaly processing component 110 is adapted to detect one or more data formatting anomalies. The anomaly processing component 110 may utilize data stored in the database 120 to detect a data formatting anomaly before it results in a processing anomaly.

Depending on the particular embodiment, the database 120 may store data such as file, protocol, and/or data structure formats; processing rules; and/or signatures. For example, in certain embodiments, the database 120 may store data about the format of an image file such as a JPEG or a Windows Metafile. As another example, in certain embodiments, the database 120 may store data including a digital signature for a particular binary file. The digital signature may be used to identify and/or validate the binary file, for example.

In certain embodiments, the database 120 is incorporated as part of the anomaly processing component 110. For example, the format of an image file, contained in the database 120, may be implemented as part of the anomaly processing component 110 in the form of code written to interpret the particular image data file format.

In certain embodiments, the anomaly processing component 110 is adapted to prevent a data processing anomaly as discussed herein. That is, while the various embodiments are discussed primarily with respect to detection of anomalies, in certain embodiments, the anomaly processing component is further adapted to prevent a detected data processing anomaly. In certain embodiments, the anomaly processing component 110 may prompt a user when an anomaly is detected. Thus, a user may still allow the data processing to occur, even if an anomaly has been detected.

In certain embodiments, the anomaly processing component 110 is adapted to restrict digital signature verification attempts, based on processing of data that is expected by the system to contain a digital signature, to the condition where the digital signature data is exactly the correct length for such digital signature data according to the digital signature scheme that is being used.

Certain embodiments prevent buffer overflows. Simply detecting when a buffer over flow is attempted through memory protection results in system resources being utilized. So although the buffer overflow is not successful, the improper overwrite is still attempted, and system resources are wasted dealing with this exception condition, turning the buffer overflow attack into a denial of service attack. For example, maliciously malformed digital signature data may cause a buffer overflow in digital signature processing logic or circuitry without the preventative defense provided by embodiments of the present invention. If the length in bytes of a signature being verified does not exactly match the length in bytes of a valid digital signature for the length that is expected in the relevant digital signature scheme, then signature verification is aborted or is never attempted in the first place and is considered to have failed. This step prevents attacks against the cryptographic digital signature verification process of a system. Commonly, digital signature verification is added as a feature to a vulnerable system through the inclusion of a cryptographic library, such as one that supplies source code or object code implementing the cryptographic algorithms and protocols necessary to verify digital signatures. Certain embodiments of the present invention prevent attacks such as buffer overflow attacks targeting such a library, in the event that the cryptographic library is found to expose vulnerabilities that can only be exploited by an attacker by providing a malicious signature block that does not conform to the length of a proper digital signature compatible with the cryptographic library. Such vulnerabilities in digital signature verification are of particular concern because even systems such as certain embodiments of the present invention, which are designed to employ a digital signature verification process before allowing additional processing of data that might be malformed or dangerous, are themselves potentially-vulnerable to a malformed digital signature. The attempt to verify the digital signature by such a system may result in a security breach as by way of a buffer overflow. A vulnerability in the system's cryptographic library implementation of digital signatures that is exploitable by passing a malicious signature block that corresponds to the correct expected length of a signature for the system may result in a remote-exploitable vulnerability, meaning that an attacker may be able to mount a successful attack merely by crafting data of the expected length and sending that data to the system for processing by its digital signature verification process. Defenses against this remaining threat that are commonly used include compiling cryptographic library source code using the Guard Stack (/GS) “Buffer Security Check” Code Generation setting of the Microsoft Visual C++ 7 compiler. This should block exploitation of any stack-based buffer overflow vulnerabilities in the cryptographic library, if the system developer has a copy of the source code for the cryptographic library that is used in the system. However, embodiments of the present invention receive substantial protection by preventing anomalies such as excessively long or incorrectly short lengths for data that is expected to be of a particular length, such as digital signature data.

In certain embodiments, the anomaly processing component 110 is adapted to insert code at the point of vulnerability to detect and prevent the exploitation of vulnerabilities that would otherwise be exploitable using malformed data to trigger specific unwanted processing. Real time alerts may be triggered by actual attacks in certain embodiments, based on the fact that the anomaly processing component is adapted to identify precisely the malformed data that is known to cause exploitation of certain vulnerabilities in a vulnerable application or vendor system. These alerts can serve as to warn the user that an exploit was blocked in cases where the intentions are clear, or prompt the user about a suspicious format and allow them to control weather it gets passed on to be processed. These alerts may come in the form of Event Log entries, pop-up dialog boxes, alert emails or any other of the commonly-used notification mechanisms. These alerts may also be sent to a network management system or other monitoring device such as by way of Simple Network Management Protocol (SNMP) protocol messages.

In certain embodiments, the anomaly processing component 110 is adapted to prevent exploitation of port 80 vulnerabilities. For example, malicious and/or malformed content that arrives at a computing system, having passed through a firewall that was unable to detect the malicious and/or malformed content.

An example of a vulnerability is the LoadImage vulnerability. The LoadImage function is found in User32.dll on the Windows operating system. Exploiting the vulnerability involves supplying maliciously malformed graphic image data or data that masquerades as graphic image data resulting in the Windows operating system or vulnerable application software invoking the LoadImage Application Programming Interface (API) to process the bad graphic image data, which may be an icon file. When the application or the operating system invokes the LoadImage function, the operating system (e.g., Windows) normally returns either a handle to the icon or an error. If the icon that was loaded is maliciously malformed, however, a buffer overflow may occur inside of User32.dll, allowing arbitrary code to be executed by the creator of the malformed icon file. Certain embodiments eliminate this vulnerability by injecting a Hook DLL into an application. For example, the Hook DLL may be injected into every application that executes on a host computer. The Hook DLL disassembles the LoadImage function and modifies it in-memory to force the function to call a hook function that is adapted to verify the icon being loaded is safely-structured according to the rules of the graphic image data format specification for such icon graphics. Thus, when the modified LoadImage API is invoked, the hook function examines the icon and detects attempts to exploit the known vulnerability in the LoadImage function. Because the hook function is now effectively part of the LoadImage function, no signature is needed to identify, detect or prevent individual malformed icons. Rather, the potential data input to the LoadImage API function can be analyzed directly before allowing the API to attempt to process the potentially-malformed data, with no risk of a false positive or any requirement that malicious graphic image signatures be updated in the future for the detection of new threats, as do scanners that simply look for problems based on a virus or malware signature. Certain embodiments provide for runtime process injection. The above-described technique may be used to deal with other threats as well.

In certain embodiments, the anomaly processing component 110 is adapted to detect malicious and/or malformed Microsoft Windows Metafile and/or Enhanced Metafile data structures and intercepts the creation and processing of Windows Metafile (WMF) and Enhanced Metafile (EMF) files. When these files are created, accessed or read via stream a hook module for the anomaly processing component 110 detects the Metafile data and first verifies that the various commands in the Metafile, which in essence is a large binary script file, are properly formatted, have reasonable values, and have values that are consistent with the file's apparent content. If the content is found to be of a valid structure and no anomalies are detected then the data is passed on to the Windows API that handles the processing of the data. Because heuristics and consistency checks are used to verify the validity of the data, scanning for known exploits or known virus code, such as by using a database of virus definitions, is avoided, and the ability to block against future variations of the exploit is greatly enhanced.

In certain embodiments, the anomaly processing component 110 is adapted to cause an application to utilize an encrypted network communication protocol. That is, the anomaly processing component 110 causes an application to use a protocol where received data must be decrypted. For example, the anomaly processing component 110 may convert a hypertext transfer protocol (http) communication attempt into one that utilizes the secure hypertext transfer protocol (https) instead. The anomaly processing component 110 is able to detect an attempt to process anomalous addresses and respond by preventing such anomalous addresses from being processed by application programs, by APIs, or by the operating system on a protected device.

In certain embodiments, the anomaly processing component is adapted to detect anomalies in network protocols. This feature extends anomaly processing component 110 in certain embodiments to perform validation of data sent or received according to well-known network protocols, without the need for explicit proxy settings to be configured. Anomaly processing component 110 may be adapted to redirect outbound network traffic through the component. This component, which is in a sense a proxy server or a white-hat man-in-the-middle, can then validate that the network protocol is well-structured and conforms to the expected formatting rules imposed by specification or by de facto standard based on observations forensically to determine a range of expected, allowable specification variations. A similar adaptation exists in certain embodiments of the present invention wherein network protocol structures are verified, according to specifications or other rules, for data that is received from the network before that data is processed by applications, APIs, or an operating system that is potentially-vulnerable to maliciously-malformed data.

In certain embodiments, the anomaly processing component 110 is implemented as function prologues and epilogues that implement protection through runtime code modification similar to the technique employed by using the Guard Stack (/GS) “Buffer Security Check” Code Generation setting of the Microsoft Visual C++ 7 compiler.

In certain embodiments, the anomaly processing component 110 is adapted to verify a file format before an application is allowed to process the data. A growing trend in information security over the past few years has been the discovery of security vulnerabilities in the processing of data stored in complex file formats. Whereas vulnerabilities in network protocols and code libraries have become increasingly rare as they are hunted to extinction, the huge number of file formats and the complexity of processing data contained in complex formats is emerging as a virtually untapped source of security holes. Recent examples include the GDI+, LoadImage, and .ANI file vulnerabilities, to name a few. In certain embodiments the anomaly processing component 110 is adapted such that it verifies that data files are well-formed, according to the aforementioned specifications and rules, before allowing them to be processed. Such adaptation includes a simple way of describing how the data in a file ought to be structured, and then mediates applications' attempts to open, use, or process files of that data structure type, verifying that data is correctly formed, and blocking the attempt to open, use, or process the data, which may be in the form of a file, if it is not. By defining sets of verification rules for various common file formats such adaptation is able to protect against vulnerabilities in how the data within files is processed, even before specific vulnerabilities are discovered that might be exploitable using maliciously-malformed structured data. In addition, with a suitably simple language for describing the structure of files certain adaptations are able to be used to rapidly respond to new instances of this class of vulnerability that arise in the future but were not anticipated.

In certain embodiments, the anomaly processing component 110 is adapted to fix root causes of security vulnerabilities in programmable computers or microprocessors. A root cause is a fundamental flaw or problem in an operating system, application, or microprocessor design that prevents such problems from being protected against without additional defensive adaptations, which flaws or problems give rise to specific vulnerabilities, exploits, threats and variants thereof. Unlike patches from software vendors which come out infrequently, are specific to only the vendor's application, and often much time goes by between a problem being discovered and a fix coming out, certain embodiments provide protection against known root causes of vulnerabilities that affect a variety of applications from different vendors. One example of a root cause solution is an embodiment of the present invention that is adapted to detect and prevent Metafile structured data anomalies. The Metafile GDI routines were vulnerable because no checking of input values was done at the time they were written. Traditional methods to fix the problem generate a virus signature, or virus definition, based on known exploits. In certain embodiments of the present invention, however, the knowledge gained by reverse engineering each of the functions involved in creating a Metafile image and the knowledge gained by reviewing the Metafile structure specification are used to create a reliable structure anomaly detection component such as anomaly processing component 110 able to verify, before each function was called, that the Metafile data is not an anomaly. Certain embodiments may take steps to ensure that the values passed in to application programming instructions are reasonable and applicable for the expected structure of data being processed. For example, certain embodiments may be adapted to examine a file's size. The maximum file size for a WMF image is 4 GB. So, if an embodiment is adapted to verify that the image is 4 GB in size, or shorter, such file size may be considered “reasonable” and may not be an anomaly for WMF files. But if the embodiment detects that the file size is only 2 k, yet the data in the file structure indicates the file is 4 GB in size, the embodiment may detect that particular Metafile data as an invalid anomaly because it fails the applicable test for an exact match between the actual size of the file and the size that is indicated within the structured data contained in the file.

In certain embodiments, the anomaly processing component 110 is adapted to eliminate the window of exposure. The window of exposure is the time between a vulnerability being identified and a fix being provided by a vendor. For certain vulnerabilities, historically, the window of exposure has been on the order of 6 months to a year in some cases. Some vulnerabilities, infrequently, are never fixed by vendors and the window of exposure never closes. Certain embodiments block the attack vectors used by may different worms and viruses before they are released, by closing the window of exposure using the anomaly processing component 110, which blocks attempts to exploit such vulnerabilities whether or not a vendor ever decides to release a fix. Some fixes released by vendors, historically, have introduced new vulnerabilities or failed to comprehensively fix the flaw that was found, yet certain embodiments of the present invention are able to prevent the exploitation of lingering vulnerabilities, anyway, because detecting and preventing anomalies is an inherently superior way to deliver fixes to problems in the vendors' products. Certain embodiments do not make permanent changes to applications, but rather modify the runtime, in-memory versions of vendor software. In certain embodiments, the anomaly processing component 110 makes changes to data stored within Random Access Memory (RAM) on a computer at runtime, in order that such changes may be easily reversed and new changes may be made whenever they are needed, such as to reinstate, reactivate, or replace the database 120 or update anomaly processing component 110. Vendor updates take a long time to create and test. When a system administrator receives new updates, they must also test their systems to ensure that there are no compatibility issues with the updates. This all leads to a large gap in time between when a vulnerability is discovered and when vulnerable systems are finally protected. To reduce this window of exposure, certain embodiments of the present invention may adapt an update anomaly processing component 110 to inject programming instructions such as executable machine code into a process at runtime within a vulnerable application to enable a solution to the vulnerability to be quickly developed based on detecting and preventing new anomalies, and an update for the embodiment may be delivered by a provider server or a customer local update server to protected customer hosts. Because the anomaly processing component 110 may, in certain embodiments, exist only in RAM at runtime, such as an embodiment that injects a Metafile dynamic link library hook using methods known in the art that enable such in-process DLL code injection, the vulnerability can be easily disabled on the customer host and if any incompatibilities are found between the application process being protected and the anomaly processing component 110 that is adapted to provide such protection then the anomaly processing component 110 may be easily disabled to restore the application to its original vulnerable state.

In certain embodiments, anomaly processing component 110 makes changes in RAM at runtime not only to its own programming instructions, which may also be stored in RAM, but also causes changes to any aspect of an application, rewriting the application's programming instructions entirely if the anomaly processing component 110 chooses to do so. This reprogramming of application programming instructions may, in certain embodiments, be accomplished by the use of hardware such as a coprocessor, microprocessor, Field Programmable Logic Array (FPLA), Application Specific Integrated Circuit (ASIC), Read Only Memory (ROM), smart card, or integrated circuit. Certain embodiments of the present invention allow a user of the system to selectively remove a portion of vendor programming instructions, where these portions of such programming instructions may be added to anomaly database 120 and may be considered henceforth to be anomalies that are detected or prevented like any other anomaly. In certain embodiments of the present invention the system itself includes the ability for a user to configure the system, and by so doing cause the selective removal of unwanted portions of programming instructions, where the removal causes the anomaly database 120 to be updated reflecting the removal so that anomaly processing component 110 can be adapted to prevent the unwanted reintroduction of such removed instructions, even at runtime. Certain embodiments may include the ability to auto-update programming instructions by receiving new or updated programming instructions, as from a provider server or from a customer local update server, for example. In embodiments that include the ability to auto-update the system that receives, verifies and processes the updates and activates them in-memory may do so before, or instead of, storing those updates in files on a hard drive, for example. In such embodiments, the anomaly processing component 110 may be adapted to be capable of detecting newly-introduced programming instructions as anomalies and may further prevent such newly-introduced programming instructions from executing at run-time. Certain embodiments of the present invention may adapt anomaly processing component 110 to detect or prevent newly-introduced programming instructions for applications that coexist with the system, as in vendor applications.

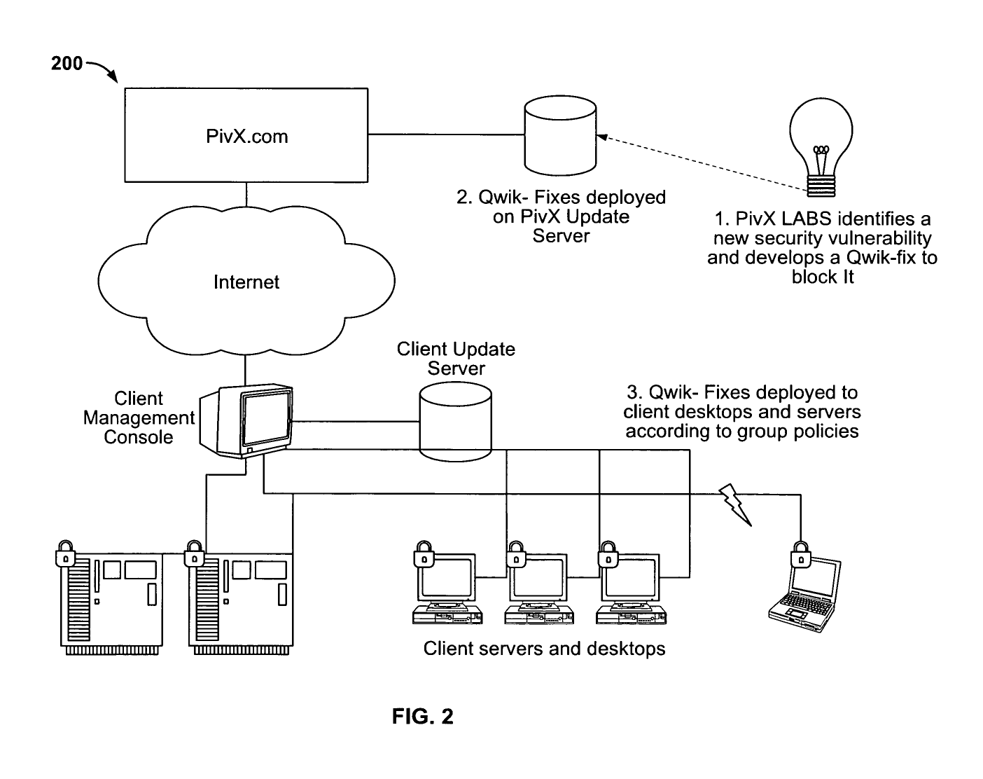

FIG. 2 illustrates a system 200 for delivery of data processing anomaly prevention and detection updates according to an embodiment of the present invention that adapts customer hosts to defend against new security vulnerabilities using a plurality of secure update servers and secure updates. In certain embodiments of the present invention, individual security vulnerabilities may be blocked from exploitation for any maliciously-malformed data that is designed to exploit the vulnerability, through deployment of reliable, accurate validation of data structures according to specifications for formatting of valid well-formed data of the specified type and structure. For safety relative to sending updates to protected customer computers, certain embodiments rely on a customer update server. Cryptographic protections and digital signatures are employed by certain embodiments to provide additional security relative to sending updates. In certain embodiments the updates are first sent to a provider server such as an update server accessible on the Internet. Updates may be information, programming instructions, instructions to modify data or other programming instructions, and other detection and prevention logic designed to specify the rules necessary for detecting or preventing, and reporting the detection or prevention of any anomaly that becomes identifiable in some way before the anomaly is allowed to harm a system. In embodiments similar to those illustrated in system 200, management of the system spans all vulnerable computers within an organization such as a customer or client of a provider. Sending updates by way of a plurality of update servers ensures wide coverage and accessibility during high-priority update delivery, as in the case of an urgent need to deploy a defensive anomaly detection or prevention update. In certain embodiments the updates compel or instruct system components to deactivate portions of programming instructions or to reactivate portions of programming instructions that are involved in processing a data structure anomaly. In certain embodiments the programming instructions are present within the system by design as part of the operating system or vendor software desired for a component of the system and updates enable the selective removal of such preexisting programming instructions. In other embodiments the programming instructions were provided as updates to preexisting programming instructions or were provided as wholly-new components that were not previously present within the system. In either case, updates may prevent or detect anomalies by adding, removing or reconfiguring such programming instructions as may be necessary to effect a viable anomaly processing defense.

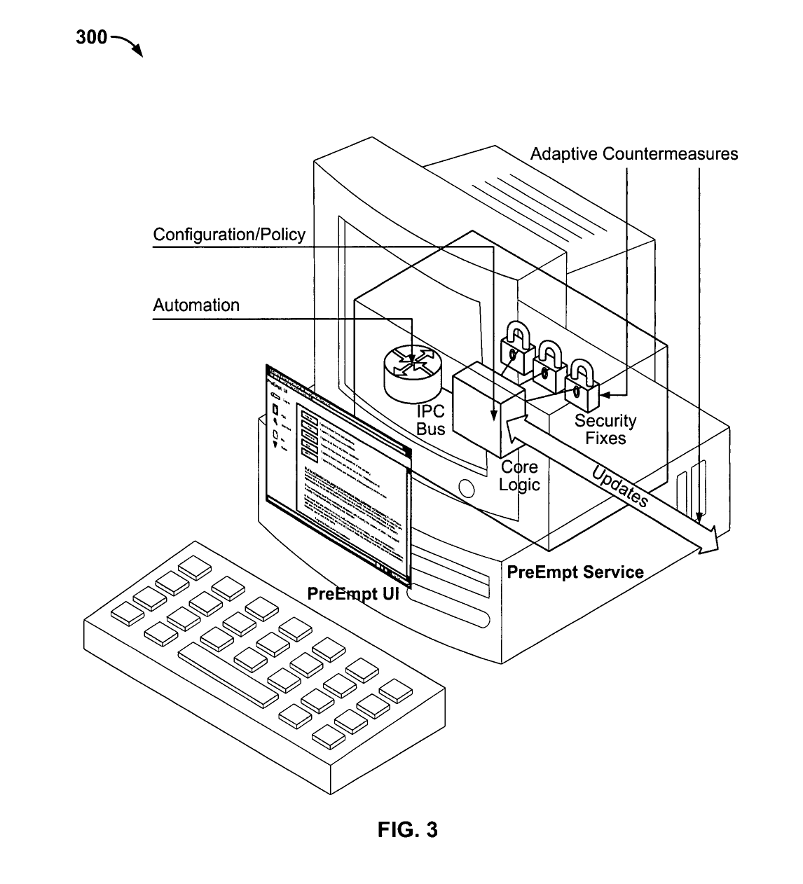

FIG. 3 illustrates a system 300 for data processing anomaly prevention and detection with a user interface, Inter-Process Communication (IPC) and the ability to receive defensive updates according to an embodiment of the present invention. Certain embodiments of the present invention resemble system 100 and incorporate a computer system with additional software features including a user interface, ability to view configuration settings, and optional third-party feature customization or integration with vendor software. In certain embodiments the system 300 is adapted to specialized applications such as kiosk public computer workstation, Internet cafe-style shared computer, or other devices that are able to execute software including but not limited to smart phones, video game consoles, and High Definition Television (HDTV) terrestrial- or satellite-based digital broadcast receivers. In certain embodiments, updates to the anomaly database are accomplished separately from other updates.

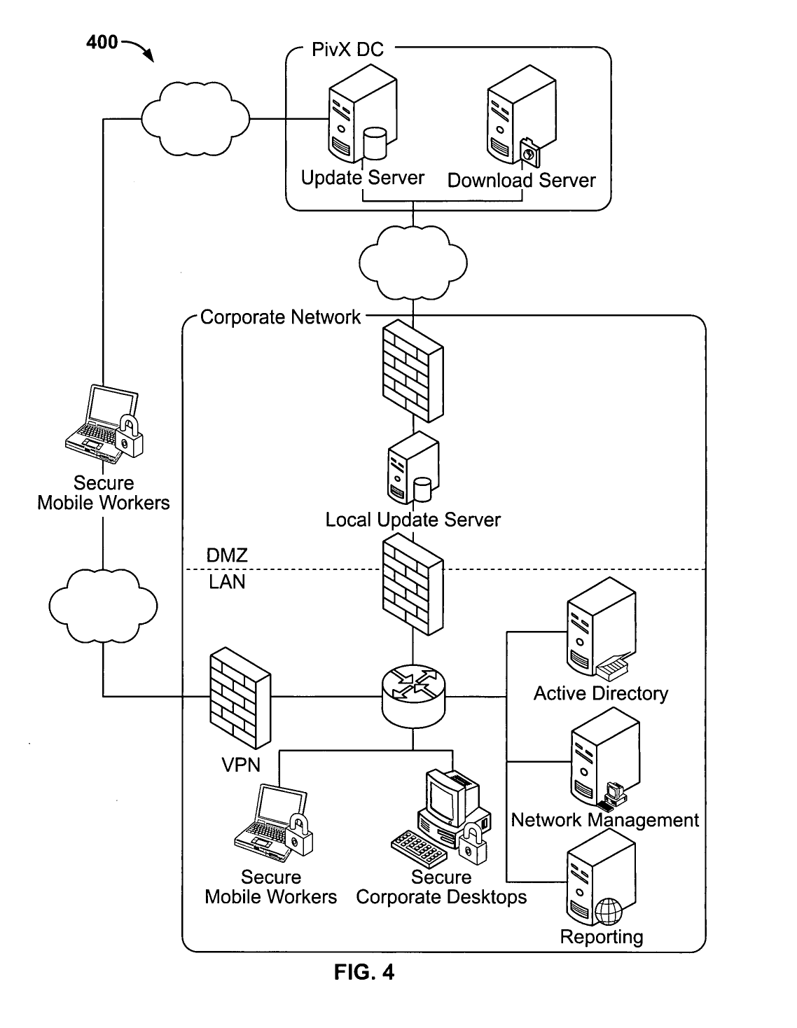

FIG. 4 illustrates a system 400 for data processing anomaly prevention and detection with a data center that services customers according to various embodiments of the present invention. Certain embodiments are adapted to accommodate the special requirements of different types of user and different network access circumstances, such as mobile hosts and hosts that require special configuration options for users who are system administrators or users who wish to have a greater degree of control over the operation and updates processed by the system. In certain embodiments a local update server communicates with the customer hosts, while in other embodiments the customer hosts communicate with an update server located in a provider data center. Some embodiment accommodate both modes of operation for all, or just for select, users. In certain embodiments there may be a high degree of security for a local update server including authentication, encryption, and a requirement that customer hosts only communicate with update servers that provide both encryption and authentication. In other embodiments there may be no authentication provided by an update server, and further there may be no encryption. These are possible embodiments, even of a secure system, because the system can use digital signatures of an adequate technical design to meet the specific security requirements of the embodiment. With digital signatures associated with each update received from an update server it may be very difficult or impossible for an attacker to compromise the system by forging any digital signature.

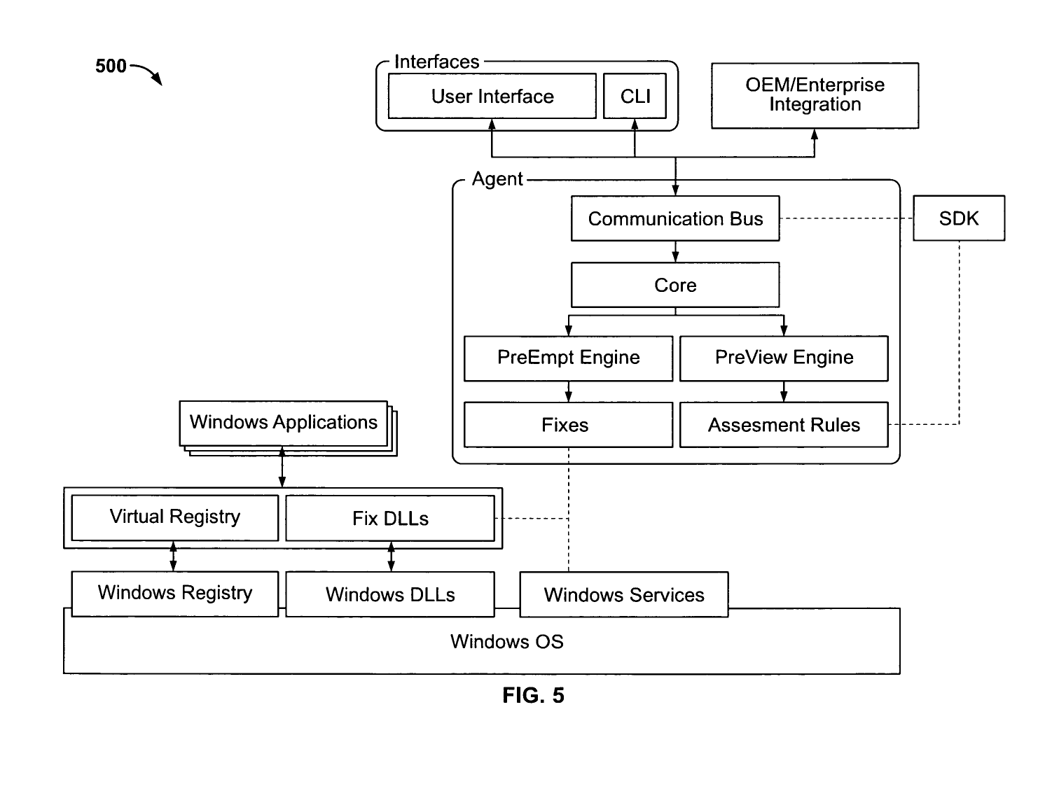

FIG. 5 illustrates a system 500 for data processing anomaly prevention and detection for a Windows computer with modular architecture adapted to customization by third-party providers according to an embodiment of the present invention. In certain embodiments there may be a plurality of providers cooperating to supply defensive protection against anomaly processing by potentially-vulnerable systems. For example, Internet Service Providers may utilize embodiments of the present invention to enable a mechanism of control over the transmission of maliciously-malformed data to subscribers by way of the service offering. Such embodiments may be especially advantageous if regulatory or legal requirements emerge that require ISPs to take financial or repair-related responsibility for harmful data that is received by customer hosts causing those hosts to malfunction, be damaged, or be compromised. Other embodiments enable cooperation between providers and an organization's information technology (IT) support staff whom may collaborate by way of an embodiment so that updates of particular importance to the particular organization might be created and deployed with priority.

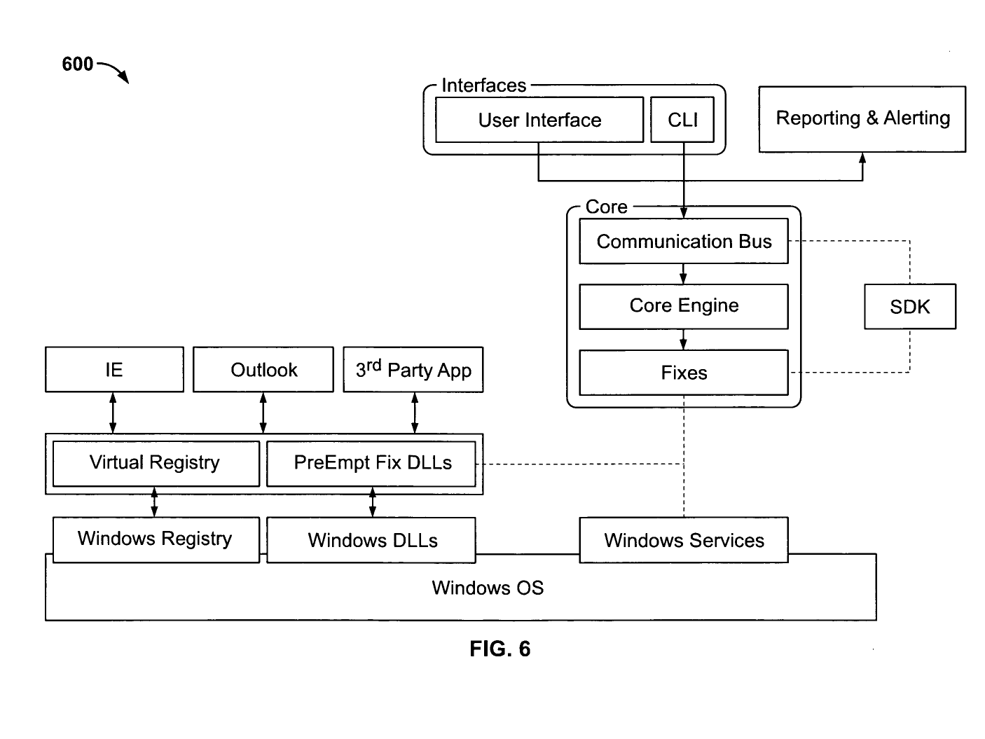

FIG. 6 illustrates a system 600 for data processing anomaly prevention and detection for a Windows computer with modular architecture adapted to operate as a layer between applications that are compatible with Windows Application Programming Interfaces and Services in accordance with an embodiment of the present invention. Certain embodiments may include special reporting and alerting functionality. Other embodiments may integrate as privileged code in the kernel of an operating system such as the Windows operating system in order to provide a new layer of defense against anomaly processing by potentially-vulnerable systems. In certain embodiments the system may be implemented as a defensive Windows service that is closely-coupled to the Windows operating system. By injecting anomaly processing layers between each distinct module in a modular operating system, a virtual exploit prevention system may be realized as an embodiment of the present invention. Certain embodiments of the present invention are anticipated to be of particular usefulness and benefit to Windows by adapting operating system modules to cooperate with anomaly prevention or detection components built-in to Windows.

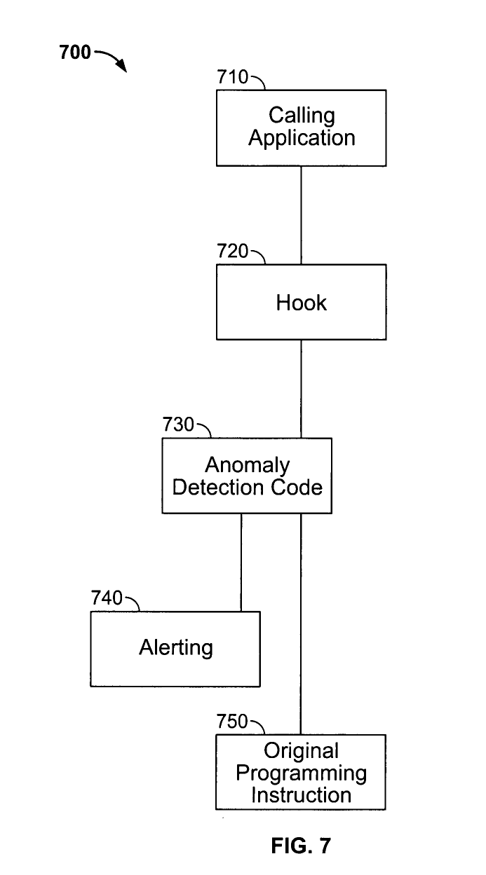

FIG. 7 illustrates a system 700 for data processing anomaly prevention and detection according to an embodiment of the present invention that inserts hooks between applications and programming instructions the applications activate that may be vulnerable to attack by way of a data anomaly. In certain embodiments of the present invention anomaly detection code is inserted by way of the hooks and alerting or reporting of detected or prevented anomalies occurs by way of such code.

The components, elements, and/or functionality of systems 100, 200, 300, 400, 500, 600, and 700 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device. Certain embodiments may replace certain steps, including steps involving the sending or receiving of updates, with expert human intervention, for example to enable careful forensic examination and analysis of updates prior to or during creation, delivery, execution or installation of such updates. Certain embodiments may employ non-automated digital signature verification performed by a human.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for data processing anomaly detection, the system including:
a database including anomaly data; and
an anomaly processing component adapted to detect a structure anomaly in data based at least in part on the database including anomaly data, wherein the data is meant to be processed by an application including at least one of data structure decoding logic and circuitry after the anomaly processing component has processed the data, wherein the anomaly processing component is adapted to prevent the application from processing the data when a structure anomaly is detected.

2. The system of claim 1, wherein the anomaly processing component is adapted to record the occurrence of detecting a structure anomaly.

3. The system of claim 1, wherein the anomaly processing component is adapted to respond to detecting an anomaly by alerting a user that the structure anomaly has been at least one of detected and prevented, and wherein the anomaly processing component is adapted to allow a user to permit the application to process the structure anomaly.

4. The system of claim 1, wherein the anomaly data includes a structure specification for data, wherein the structure specification allows at least one of a variable length for a data element and a variable number of data elements, wherein the anomaly processing component is adapted to overrule at least part of the structure specification and disallow the variability by detecting such variability as though it were a structure anomaly.

5. The system of claim 4, wherein the anomaly processing component is adapted to record the occurrence of at least one of detecting and preventing the structure anomaly.

6. The system of claim 4, wherein the anomaly processing component is adapted to respond to detecting an anomaly by alerting a user that a structure anomaly has been at least one of detected and prevented, and wherein the anomaly processing component is adapted to allow a user to permit the application to process the structure anomaly.

7. The system of claim 2, wherein the anomaly processing component is adapted to respond to detecting an anomaly by alerting a user that the structure anomaly has been at least one of detected and prevented, and wherein the anomaly processing component is adapted to allow a user to permit the application to process the structure anomaly.

8. The system of claim 3, wherein the anomaly processing component is adapted to record the occurrence of at least one of detecting and preventing the structure anomaly.

9. The system of claim 1, wherein the anomaly data includes a structure specification for the data, wherein the structure specification includes the requirement that the data be no more and no less than a predetermined length.

10. The system of claim 2, wherein the anomaly data includes a structure specification for the data, wherein the structure specification includes the requirement that the data be no more and no less than a predetermined length.

11. The system of claim 3, wherein the anomaly data includes a structure specification for the data, wherein the structure specification includes the requirement that the data be no more and no less than a predetermined length.

13. The system of claim 8, wherein the anomaly data includes a structure specification for the data, wherein the structure specification includes the requirement that the data be no more and no less than a predetermined length.

14. A system for data processing anomaly detection, the system including:
an anomaly processing component adapted to enable a user to decide whether programming instructions for an application are updated with new programming instructions when at least one of the application is not otherwise designed to give the user this ability to decide and the application includes a module that must be updated whenever programming instructions are updated.

15. The system of claim 14, further including a database including anomaly data, wherein the anomaly processing component is further adapted to allow a user to selectively remove a portion of the programming instructions and wherein information about the selectively removed portion of the programming instructions is added to the database.

16. The system of claim 15, further including a database including anomaly data, wherein the anomaly processing component is adapted to prevent the forced reinstatement of a portion of the programming instructions that were previously removed.

17. The system of claim 15, further including a database including anomaly data, wherein the anomaly processing component is adapted to reinstate programming instructions that were previously removed.

18. The system of claim 17, wherein the anomaly processing component is adapted to alert at least one of the user and another party before reinstating any programming instructions that were removed by the user.

19. The system of claim 14, wherein the application includes optional programming instructions that the user is able to selectively activate or selectively update by requesting that such update occur by using a feature of the application.

20. The system of claim 14, wherein the application includes optional programming instructions that are newly-introduced to the system without the user's knowledge.

21. The system of claim 20, wherein the anomaly processing component is adapted to enable the user to see information about the newly-introduced optional programming instructions before deciding whether programming instructions are updated.

22. A system for data processing anomaly detection, the system including:
a database including a data structure specification, wherein the data structure specification includes information about the structure of at least one of a Windows Metafile and an Enhanced Metafile data structure; and
an anomaly processing component adapted to detect an attempt to decode data of at least one of a Windows Metafile and an Enhanced Metafile data structure, wherein the anomaly processing component is further adapted verify that the data complies with rules derived from the data structure specification.

23. A system for data processing anomaly detection, the system including:
a database including anomaly data; and
an anomaly processing component adapted to detect prior to the execution of new programming instructions that the new programming instructions were created prior in time to existing programming instructions based at least in part on the anomaly data, wherein the existing programming instructions are to be updated with the new programming instructions.

24. The system of claim 23, wherein the anomaly processing component is adapted to prevent the execution of the old programming instructions by detecting old programming instructions by performing one of searching a database including anomaly data for forensic information about the chronology of the past detection of programming instructions, identifying the programming instructions as being old programming instructions by virtue of the user previously having selectively removed the programming instructions associated with a newer or more recent version number or date/time stamp than the version number or date/time stamp associated with the old programming instructions according to the database including anomaly data, querying a device or system adapted to receive forensic information about the programming instructions then return a response indicating whether the programming instructions are known to be old programming instructions, and querying the user to receive an indication from the user as to whether the user believes the programming instructions to be old programming instructions.

25. The system of claim 23, wherein the anomaly processing component is adapted to respond to detecting old programming instructions by alerting a user that the old programming instructions have been at least one of detected and prevented, and wherein the anomaly processing component is adapted to allow the user to allow the execution of the old programming instructions.

26. The system of claim 24, wherein the anomaly processing component is adapted to respond to detecting old programming instructions by alerting a user that the old programming instructions have been at least one of detected and prevented, and wherein the anomaly processing component is adapted to allow the user to allow the execution of the old programming instructions.

27. A system for data processing anomaly detection, the system including:
an anomaly processing component adapted to receive data using an address, wherein the anomaly processing component is further adapted to require the use of an address that requires decryption of the received data when an address that does not require decryption of the received data is otherwise available.

28. The system of claim 27, wherein the anomaly processing component is adapted to prevent an attempt to use an address that does not satisfy a predefined rule.

29. The system of claim 27, wherein a cryptographic system used to receive the received data provides authentication.

30. The system of claim 28, wherein a cryptographic system used to receive the received data provides authentication.

31. A method for data processing anomaly detection, the method including:
verifying new programming instructions by forensically examining the new programming instructions, wherein the new programming instructions are not examined solely by an automated system and wherein the new programming instructions are visually inspected by a human being; and
communicating the verified new programming instructions to a host adapted to install the verified new programming instructions.
